(19) United States
(12) Patent Application Publication
(10) Pub. No.: US 2018/0008099 A1
(43) Pub. Date: Jan. 11, 2018

(54) Two side cuttingboard with support base

(71) Applicant: Barbara Ann Schindel, Fond du lac, WI (US)

(72) Inventor: Barbara Ann Schindel, Fond du lac, WI (US)

(73) Assignee: Barbara Ann Schindel, Fond du Lac, WI (US)

(21) Appl. No.: 15/731,547

(22) Filed: Jun. 26, 2017

Related U.S. Application Data
(63) Continuation-in-part of application No. 62/493,534, filed on Jul. 7, 2016.

(51) Int. Cl. A47J 47/00; A47J 47/16

(52) U.S. Cl. CPC A47J 47/005; A47J 47/16

(57) ABSTRACT

A cuttingboard that has usage for either side, one side being, not limited to, embellished with artistic design, imagination of color, floral or scenic views. The reverse side for cutting, chopping and slicing foods, has two uneven basins, or vessel grooves to collect drippings or crumbs. The support base, is removable, allows the cuttingboard to display itself, upright, as well, when the support base is removed, the cuttingboard will lay flat to prep food items or display the decorative side. Two grip handles on one end of the two side cuttingboard with support base, for ease of moving. Warning is made that any prep of any food item can not be done on the design painted side, only on the reverse cutting side.

### CROSS REFERENCES TO RELATED APPLICATION

Yes

1. United States Patent Application US2014/0265088A1
Sep. 18, 2014 Cutting Board

### CROSS REFERENCE WITHOUT UNITED STATES PATENT APPLICATION

1. Williams Sonoma, Calif.
William Sonoma Essential Carving Board

### BACKGROUND OF THE INVENTION

### 1. Field of the Invention

Kitchenware or Houseware is relative to my invention since it is reversible, being called Two Side Cuttingboard with Support Base. One side is embellished with beauty and artistic elegance, pleasing each consumer with their own personal style and design to display this side in any room. The reverse side, for use of preparation of slicing, chopping and cutting food items, making prep much easier with the two uneven basins or vessel like grooves to collect or catch drippings or crumbs that happen while slicing, cutting or chopping the food items. The Support Base, which is removable, serves as a resting place, for the Two Side Cuttingboard, when not in use. The two grip handles are at one end of the cuttingboard, serves as hand brace, to move cuttingboard to another area.

### DESCRIPTION OF PRIOR ART

Produced in various sizes and shapes, the cuttingboards are designed for specific uses or jobs. It is typical for the everyday consumer to purchase a variety of cuttingboards to be used for the wide range of preparation of food items. Most often the drip basins run down the edge of both or one side of the cuttingboard and less likely to none, the cuttingboard does not have a removable support base to hold the cuttingboard when not in use, thus leaving clutter on the kitchen counters, without any decorative character.

My present invention seeks to dispose the clutter, the excess drippings and crumbs from dripping and falling to the counter will be eliminated to a smaller amount, as my present invention offers two uneven drip basins, that do not run down the edge of the cuttingboard but are nearer the center of the flat side cutting side to make catching those crumbs a bit easier.

My present invention will reduce some issues with bacteria, help improve the sanitation as it is not recommended to immerse any wood, bamboo or maple cuttingboard in water but to hand wash with soap, water and hand dry. My present invention, offers a removable support base to hold the cuttingboard after washing.

Cuttingboards, typically offer one grip handle, there may/may not have any grip edge to grab when a consumer needs to grasp the cuttingboard for use.

My present invention offers two grip handles, for use of the cuttingboard, easily grasped by a left handed or right handed consumer.

### BRIEF SUMMARY OF PRESENT INVENTION

The present invention is designed with two sides. The top side is designed to be decorative in color and character, to be designed in floral, scenic or abstract arts as shapes, forms, colors, and textures done with imagination, with paint and a clear top protective coating. The present invention has a bottom side for everyday use in the kitchen for chopping, slicing or cutting with two uneven catch basins which has a characteristic design. These two grooves will help catch those crumbs when slicing food items; as well, will catch the drippings from cutting or carving food items. These two basins are grooved nearer to the center, still leaving enough flat space to place the food item to which to be cut, carved, sliced or diced with the purpose that will catch some of the crumbs or drippings before it reaches the edge of the cuttingboard to land on the kitchen counter area. Most cuttingboards have the grooves or catch basins on the running edge of the cuttingboards.

In addition to the unique design, front and back, the present invention has two grip bars or handles, both on one end of the cuttingboard, for the exclusive use of a right handed or left handed person, while the cuttingboard is resting in the support base.

The present invention has a support base that will allow the cuttingboard to rest when not in use.

The present invention can be made of wood, bamboo or maple.

### DESCRIPTION OF THE FIGURES IN ILLUSTRATIONS AND PHOTO COPIES

Fully described with references to the accompanying illustrations and photo copies in which:

FIG. 1 a front perspective view, #1 showing the embellished, artistic design of my two side cuttingboard with #2 removable support base, #6 slot in #2 support base to display the cuttingboard when not in use in the #2 support base. The hand grips, #3 are at one end of the cuttingboard, #4 being the width of the bottom edge shown thereof;

FIG. 1 page 2 of 5, a front perspective view of #1 the embellished, artistic design, resting in #6 slots of the #2 support base, with the #3 hand grips shown thereof;

FIG. 1A page 3 of 5, a perspective view and mirror image of FIG. 1, page 2 of 5, to show detail of the #1 design side shown thereof;

FIG. 2 a perspective view of the reverse side, #8 known as the prep side, showing #9 the uneven basins, to catch the drippings or crumbs that happen while food items are prepared, #3 hand grips are at one end of the cuttingboard and #2 removable support base, #6 the slot in #2 support base to display the cuttingboard when not is use, with #4 being the width of the bottom edge shown thereof;

FIG. 2A page 4 of 5 a perspective view and a mirror image of FIG. 2, page 1 of 5, to show detail of the #8 prep side shown thereof;

FIG. 3 a perspective view of #2 support base, #6 the slot that runs in the center in length, #7 showing length, each side is mirror image and #10 the width, each end is mirror image as shown thereof;

FIG. 3A page 5 of 5, a perspective view and mirror image of FIG. 3, page 1 of 5; page 2 of 5 as shown thereof;

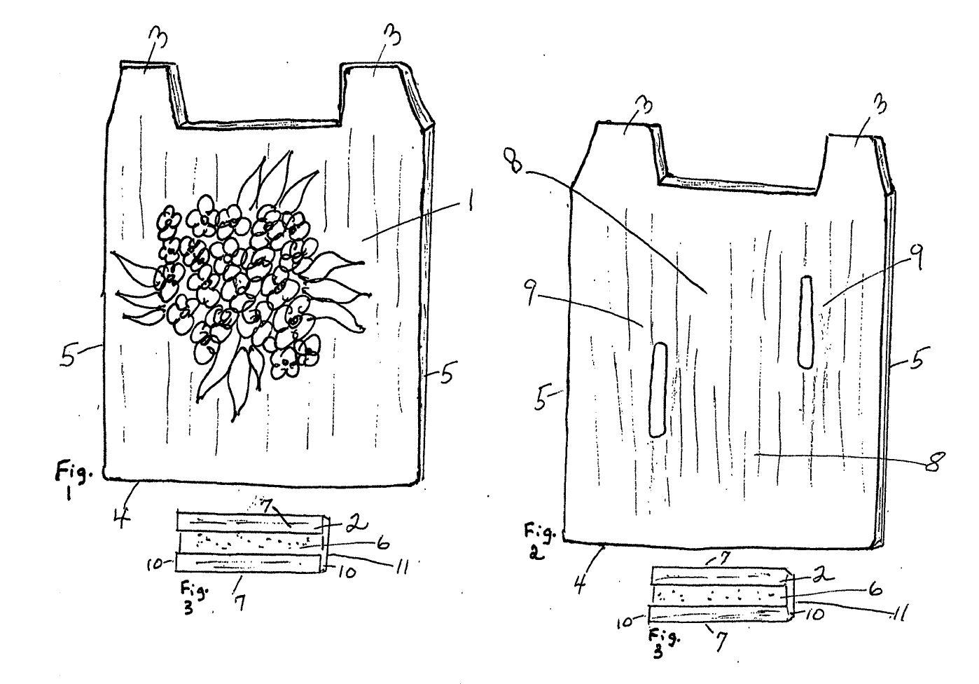

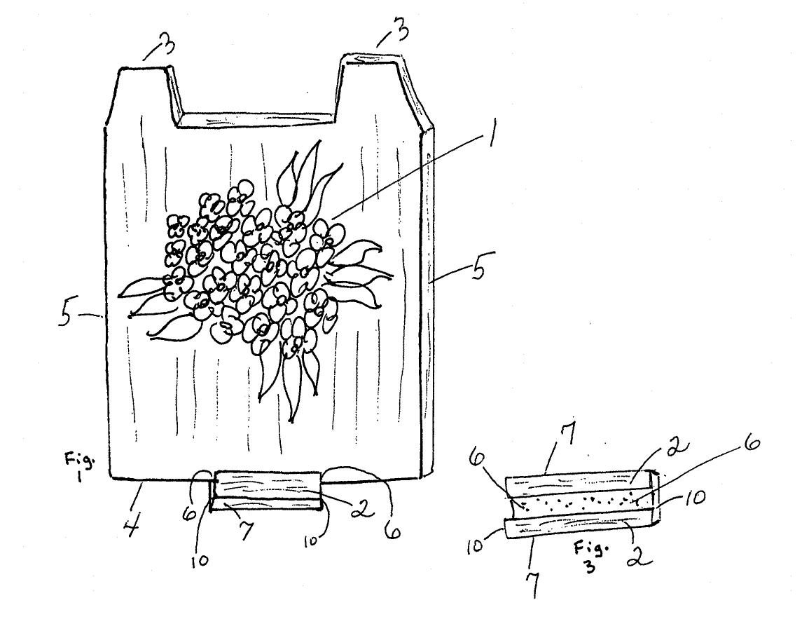

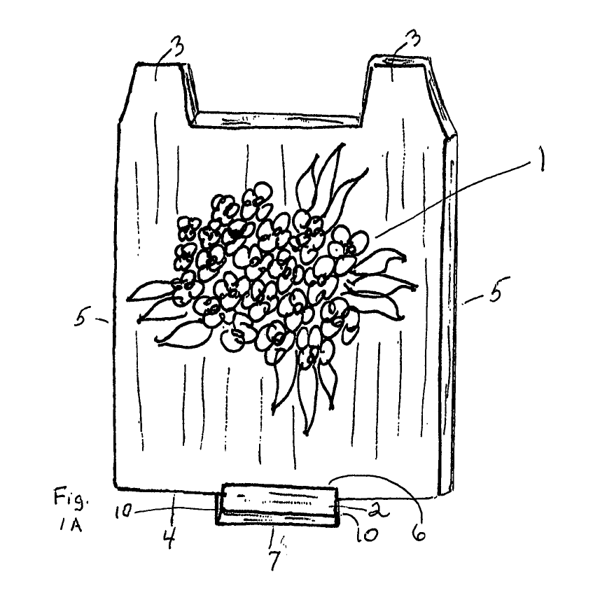

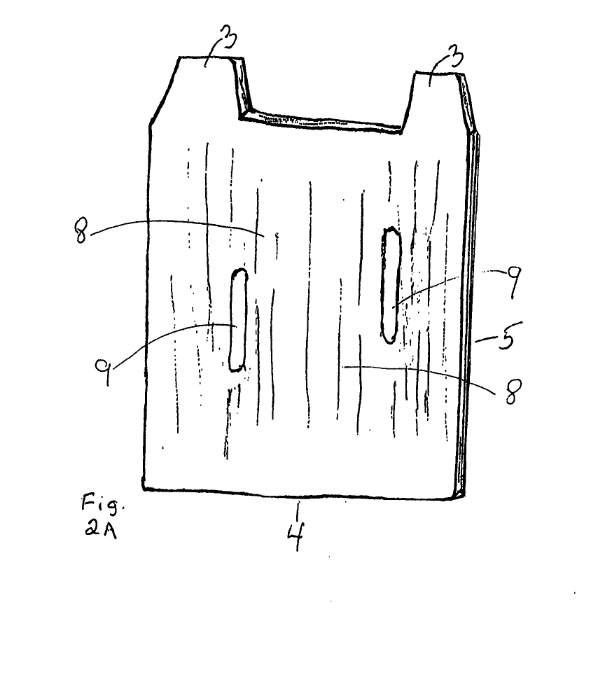

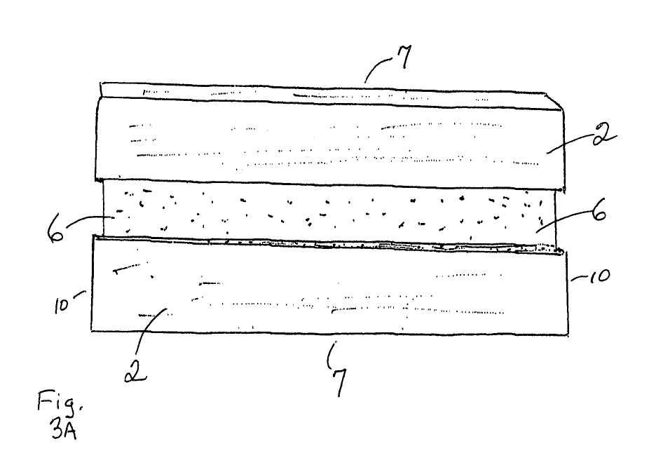

### REFERENCES

| | | |
|---|---|---|
| 1. Embellished, Artistic Design | 2. Support Base | 3. 2 Hand Grips |
| 4. Bottom Edge | 5. Right/Left Edge | 6. Open Slot of |
| | | Support Base |
| 7. Length of Support Base | 8. Prep Side | 9. Uneven Basins |
| 10. Width of Support Base | 11. Bottom of | |
| | Support Base | |

1. A tool for preparation of food product(s) which consist of a station to hold food product(s)

2. A station, as stated in claim 1, has two uneven basins to catch juices, and or crumbs that happen from prep of food product(s)

3. A tool, as stated in claim 1, and station as stated in claim 2, that has 2 grip handles on one end of tool, station, to grip if tool, station needs to be moved to another area

4. A tool that has a reverse side that is designed artistically with color and imagination

5. A prop, serving as a support base, to hold, the tool, as stated in claim 1 and claim 4
